(19) United States
(12) Patent Application Publication
(10) Pub. No.: US 2015/0106573 A1
(43) Pub. Date: Apr. 16, 2015

(54) DATA PROCESSING SYSTEM

(71) Applicant: SK hynix Inc., Gyeonggi-do (KR)

(72) Inventor: Yeong Sik YI, Gyeonggi-do (KR)

(73) Assignee: SK hynix Inc., Gyeonggi-do (KR)

(21) Appl. No.: 14/148,319

(22) Filed: Jan. 6, 2014

(30) Foreign Application Priority Data
Oct. 10, 2013 (KR) 10-2013-0120378

(51) Int. Cl. G06F 3/06

(52) U.S. Cl. CPC G06F 3/0658; G06F 3/061; G06F 3/0683; G06F 2003/0697
USPC 711/148

(57) ABSTRACT

A data processing system includes a host device including a first working memory and a data storage device suitable for responding to an access request from the host device. The data storage device includes a controller suitable for controlling an operation of the data storage device, a second working memory suitable for storing data used for driving of the controller, and an access controller suitable for accessing a shared memory region of the first working memory under the control of the controller.

### CROSS-REFERENCES TO RELATED APPLICATION

The present application claims priority under 35 U.S.C, §119(a) to Korean application number 10-2013-0120378, filed on Oct. 10, 2013 in the Korean Intellectual Property Office, which is incorporated herein by reference in its entirety.

### BACKGROUND

1. Technical Field

Various embodiments of the present invention relate to a data processing system, and more particularly, to a data processing system with a host device and a data storage device.

2. Related Art

Recently, the paradigm for the computer environment has changed into a ubiquitous computing in which computer systems may be used anytime and anywhere. Thus, the use of portable electronic devices such as mobile phones, digital cameras, and notebook computers has rapidly increased. In general, such portable electronic devices use a data storage device, which uses a memory device. The data storage device is used to store data to be used in a portable electronic device.

A data storage device using a memory device provides advantages in that, since there is no mechanical driving part, stability and durability are excellent, an information access speed is high, and power consumption is relatively low. Data storage devices having such advantages may include a universal serial bus (USB) memory device, a memory card having various interfaces, and a solid-state drive (SSD).

A portable electronic device and a data storage device may drive a firmware or a software used for their respective operations. Such firmware or software may be driven with being loaded on a working memory. That is, a portable electronic device and a data storage device may control their respective general operations through driving of the firmware or the software loaded on the respective working memories.

In order for a stable and rapid operation, it is desirable For a working memory to have large storage capacity. However, the storage capacity of the working memory is to be determined in consideration of performance and a manufacturing cost, which have a trade-off relationship to each other.

### SUMMARY

A host device and a data storage device, which share working memories and an operating method thereof, are described herein.

In an embodiment of the present invention, a data processing system may include a host device including a first working memory and a data storage device suitable for responding to an access request from the host device. The data storage device may include a controller suitable for controlling an operation of the data storage device, a second working memory suitable for storing data used for driving of the controller, and an access controller suitable for accessing a shared memory region of the first working memory under the control of the controller.

In an embodiment of the present invention, a data processing system may include a host device; and a data storage device suitable for communicating with the host device through an interface, and storing data to be accessed by the host device. The host device provides a write request for write data to the data storage device, the data storage device selects a transmission method of the write data in response to the write request and informs the selected transmission method to the host device, and the host device transmits the write data based on the selected transmission method.

In an embodiment of the present invention, a data processing system may include a host device with a first working memory, and a data storage device suitable for responding to an access request from the host device. The data storage device includes a controller with a second working memory and suitable for controlling an operation of the data storage device, an access controller suitable for accessing a shared memory region included the first working memory under the control of the controller, and a data storage medium suitable for storing data provided from the host device.

According to the embodiments of the present invention, the performance of a data storage device may be improved through extension of a working memory.

### BRIEF DESCRIPTION OF THE DRAWINGS

Features, aspects, and embodiments are described in conjunction with the attached drawings, in which:

FIG. 1 is a block diagram illustrating a data processing system in accordance with an embodiment of the present invention;

FIG. 2 is a block diagram for explaining a unified region access controller shown in FIG. 1;

FIG. 3 is a diagram for explaining the extended working memory region of a data storage device shown in FIG. 1;

FIG. 4 is a flow chart for explaining operations of the data processing system in accordance with the embodiment of the present invention;

FIG. 5 is a flow chart illustrating a method of using an unified region of a data processing system in accordance with the embodiment of the present invention;

FIG. 6 is a block diagram illustrating a data processing system in accordance with an embodiment of the present invention;

FIG. 7 is a block diagram illustrating a data processing system with a solid-state drive (SSD) in accordance with an embodiment of the present invention; and

FIG. 8 is a detailed diagram of an SSD controller shown in FIG. 7.

### DETAILED DESCRIPTION

In the present invention, advantages, features and methods for achieving them will become more apparent after a reading of the following exemplary embodiments taken in conjunction with the drawings. The present invention may, however, be embodied in different forms and should not be construed as being limited to the embodiments set forth herein. Rather, these embodiments are provided to describe the present invention in detail to the extent that a person skilled in the art to which the invention pertains can easily enforce the technical concept of the present invention.

It is to be understood herein that embodiments of the present invention are not limited to the particulars shown in the drawings and that the drawings are not necessarily to scale and in some instances proportions may have been exaggerated in order to more clearly depict certain features of the invention. While particular terminology is used herein, it is to be appreciated that the terminology used herein is for the purpose of describing particular embodiments only and is not intended to limit the scope of the present invention. Throughout the disclosure, reference numerals correspond directly to the like numbered parts in the various figures and embodiments of the present invention.

As used herein, the term “and/or” includes any and all combinations of one or more of the associated listed items. It will be understood that when an element is referred to as being “on,” “connected to” or “coupled to” another element, it may be directly on, connected or coupled to the other element or intervening elements may be present. As used herein, a singular form is intended to include plural forms as well, unless the context clearly indicates otherwise. It will be further understood that the terms “includes ” and/or “including,” when used in this specification, specify the presence of at least one stated feature, step, operation, and/or element, but do not preclude the presence or addition of one or more other features, steps, operations, and/or elements thereof.

Hereinafter, a data processing system according to the present invention will be described below with reference to the accompanying drawings through exemplary embodiments.

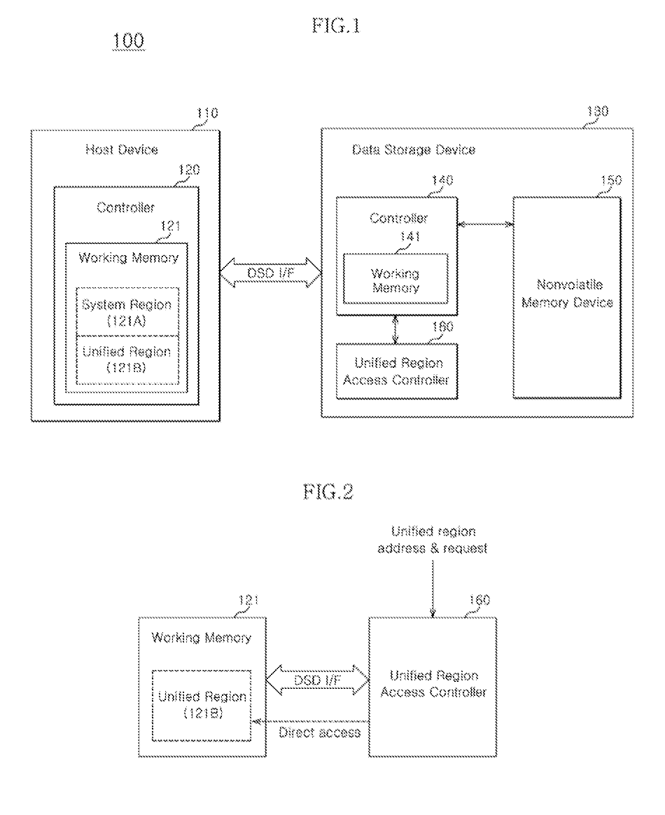

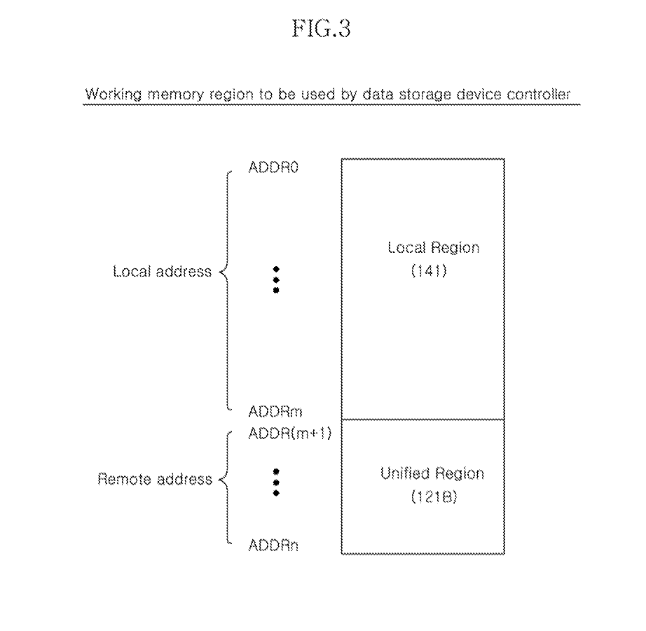

FIG. 1 is a block diagram illustrating a data processing system 100 in accordance with an embodiment of the present invention. FIG. 2 is a block diagram for explaining a unified region access controller 160 shown in FIG. 1.

Referring to FIG. 1, the data processing system 100 may include a host device 110 and a data storage device 130.

The host device 110 may include a portable electronic device such as a mobile phone, an MP3 player and a laptop computer, or an electronic device such as a desktop computer, a game player, a TV, a projector and a car entertainment system.

The host device 110 may include a controller 120 and a working memory 121. While it is shown that the working memory 121 is included in the controller 120, the working memory 121 may be disposed outside the controller 120.

The controller 120 may control the general operations of the host device 110. The controller 120 may drive a firmware or a software for controlling the general operations of the host device 110. The controller 120 may drive a firmware or a software, which is loaded on the working memory 121.

The working memory 121 may be classified into a system region 121A and a unified region (or a sharable region or shared region) 121B. The system region 121A may be a memory region, which may be accessed or used by only the controller 120 of the host device 110. That is, the system region 121A may be a region for which an occupation authority (or an access authority) is exclusively granted to the controller 120 of the host device 120. A firmware or a software used for the operation of the controller 120 of the host device 110 and data used for driving the firmware or the software may be stored in (or loaded on) the system region 121A of the working memory 121.

The unified region 121B may be a shareable memory region, which may be accessed or used by the controller 120 of the host device 110 and a controller 140 of the data storage device 130. That is, the unified region 121B may be a region for which an occupation authority (or an access authority) is granted to both the controller 120 of the host device 110 and the controller 140 of the data storage device 130. As the occupation authority is shared, the unified region 1216 may be recognized and allocated as the extended region of a working memory 141 of the data storage device 130.

The data storage device 130 may operate in response to a request from the host device 110. The data storage device 130 may store data to be accessed by the host device 110. In other words, the data storage device 130 may be used as a main memory device or an auxiliary memory device of the host device 110. The data storage device 130 may also be referred to as a memory system.

The controller 140, the working memory 141, a nonvolatile memory device 150, and a unified region access controller 160 may form a memory card. Alternatively, the controller 140, the working memory 141, the nonvolatile memory device 150 and the unified region access controller 160 may form a solid-state drive (SSD). Each of the memory card and the SSD may be coupled with the host device 110 through various interfaces, that is, various data storage device interfaces DSD I/F.

The data storage device 130 may include the controller 140, the working memory 141, the nonvolatile memory device 150, and the unified region access controller 160. While it is shown that the working memory 141 is included in the controller 140, the working memory 141 may be disposed outside the controller 140.

The controller 140 may control the general operations of the data storage device 130. The controller 140 may drive a firmware or a software for controlling the general operations of the data storage device 130. The controller 140 may drive a firmware or a software, which is loaded on the working memory 141.

The working memory 141 may be a memory region, which may be accessed or used by only the controller 140. The working memory 141 may store a firmware and data used for the operation of the controller 140. The working memory 141 may temporarily store data to be transmitted from the host device 110 to the nonvolatile memory device 150 or from the nonvolatile memory device 150 to the host device 110. Namely, the working memory 141 may operate as a buffer memory device or a cache memory device.

The controller 140 may control the nonvolatile memory device 150 in response to a request from the host device 110. For example, the controller 140 may provide the data read from the nonvolatile memory device 150 to the host device 110. In another example, the controller 140 may store the data provided from the host device 110 in the nonvolatile memory device 150. For these operations, the controller 140 may control the read, program (or write) and erase operations of the nonvolatile memory device 150.

The nonvolatile memory device 150 may operate as the storage medium of the data storage device 130. The nonvolatile memory device 150 may include any one of various types of nonvolatile memory devices such as a NAND flash memory device, a NOR flash memory device, a ferroelectric random access memory (FRAM) using ferroelectric capacitors, a magnetic random access memory (MRAM) using a tunneling magneto-resistive (TMR) layer, a phase change random access memory (PRAM) using a chalcogenide alloy, and a resistive random access memory (ReRAM) using a transition metal oxide. The ferroelectric random access memory (FRAM), the magnetic random access memory (MRAM), the phase change random access memory (PRAM) and the resistive random access memory (ReRAM) are one kind of nonvolatile RAM devices, which are capable of a random access to a memory cell. The nonvolatile memory device 150 may include a combination of a NAND flash memory device and at least one of the various types of nonvolatile memory devices, for example, nonvolatile RAM devices, described above.

The controller 140 may request an access to the unified region 121B, to the unified region access controller 160 when an access to the unified region 121B is needed. As described above, when the unified region 121B is recognized and allocated as the extended region of the working memory 141, the controller 140 may provide an address and an access request for accessing the unified region 1216 to the unified region access controller 160.

The unified region access controller 160 may directly perform an access to the unified region 1216, in place of the controller 140. That is, as shown in FIG. 2, the unified region access controller 160 may access the unified region 121B in response to the address and the request provided from the controller 140. The unified region access controller 160 may perform an access to the unified region 121B through the data storage device interface DSD I/F.

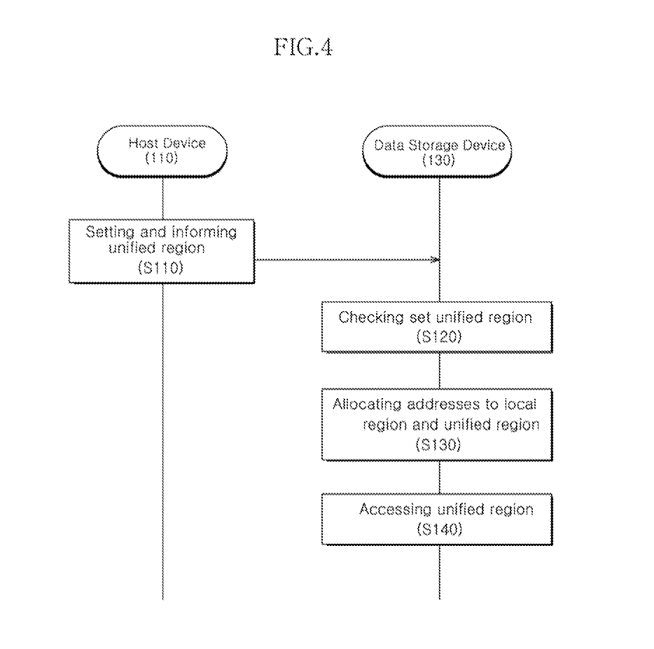

FIG. 3 is a diagram for explaining the extended working memory region of the data storage device shown in FIG. 1.

As described above, the unified region 1216 may be a shareable memory region, which may be accessed or used by the controller 120 of the host device 110 and the controller 140 of the data storage device 130. Since the unified region 121B is a shareable memory region, the unified region 121B may be recognized and allocated as the extended region of the working memory 141 of the data storage device 130.

The controller 140 of the data storage device 130 may recognize and allocate the memory region of the working memory 141 as a local region which may be exclusively occupied. For instance, the controller 140 may allocate addresses for accessing the local region 141, that is, local addresses ADDR0 to ADDRm, according to the size of the working memory 141.

Further, the controller 140 of the data storage device 130 may recognize the unified region 121B as an extended region and may allocate addresses. For instance, the controller 140 may allocate addresses for accessing the unified region 121B, that is, remote addresses ADDR(m+1) to ADDRn according to the size of the unified region 1216.

The controller 140 of the data storage device 130 may recognize the local region 141 and the unified region 1216 as one usable working memory region through sequential allocation of the local addresses ADDR0 to ADDRm and the remote addresses ADDR(m+1) to ADDRn. This means that a working memory region, which may be used by the controller 140 of the data storage device 130, may be extended.

When the unified region 1216 may be accessed by the controller 140, the unified region 1216 may be employed for the same use as the local region 141. In other words, data to be stored in the local region 141 may be stored in the unified region 1216. For instance, a firmware or a software to be stored in the local region 141 may be stored in the unified region 1216. For another instance, data to be stored in the nonvolatile memory device 150 and data to be read from the nonvolatile memory device 150 may be stored in the unified region 121B. Namely, the unified region 121B may be used as the buffer memory region or the cache memory region of the data storage device 130.

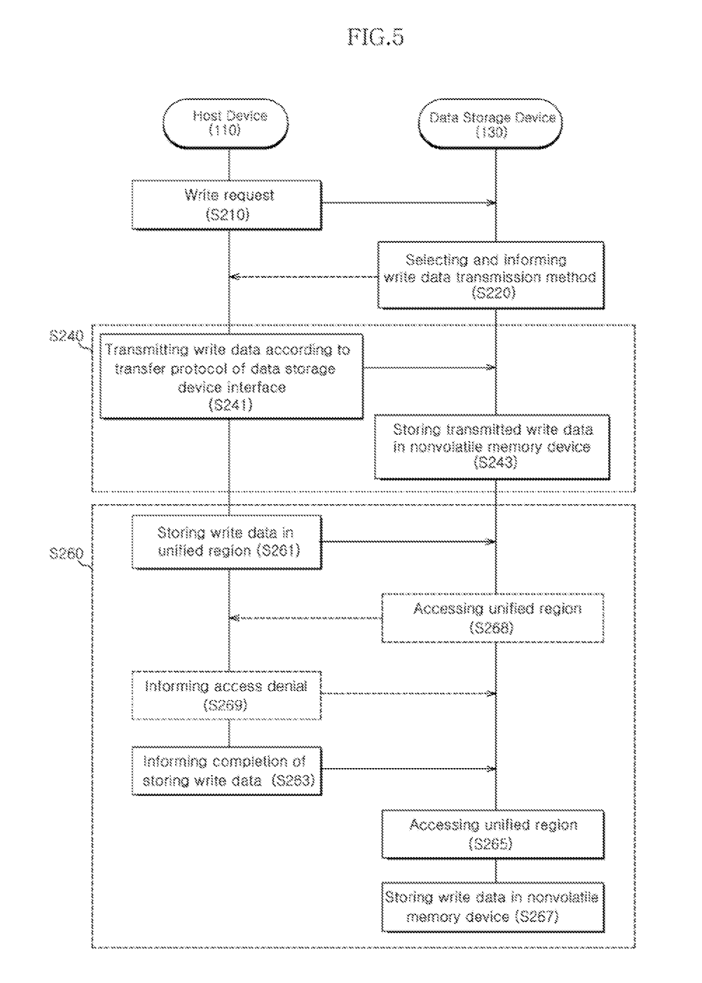

FIG. 4 is a flow chart for explaining operations of the data processing system shown in FIG. 1.

Referring to FIG. 4, a procedure in the host device 110 and the data storage device 130 for extending the working memory region of the data storage device 130 through sharing of the unified region 121B is exemplarily shown.

In step S110 the host device 110 may set the unified region 121B and may inform information on the set unified region 121B to the data storage device 130. The host device 110 may set remaining memory regions excluding regions to be used as the system region 121A, among the memory regions of the working memory 121, as the unified region 121B. The host device 110 may fix or change the size of the unified region 121B. The host device 110 may inform the size information of the set unified region 121B or the address information of the unified region 121B to the data storage device 130.

In step S120, the data storage device 130 may check the set unified region 121B on the basis of the information on the unified region 121B, which is informed from the host device 110. For instance, the data storage device 130 may check the size of the unified region 121B or the address information for accessing the unified region 121B.

In step S130, the data storage device 130 may allocate addresses for the local region, that is, the memory region of the working memory 141, and the unified region 121B. For instance, as shown in FIG. 3, the data storage device 130 may allocate addresses for accessing the local region 141 and the unified region 121B. Exemplarily, the data storage device 130 may sequentially allocate addresses such that addresses for accessing the local region 141 and the unified region 121B are successive.

In step S140 the data storage device 130 may access (or use) the unified region 121B according to an allocated remote to address. The data storage device 130 may perform an access to the unified region 121B through the unified region access controller 160.

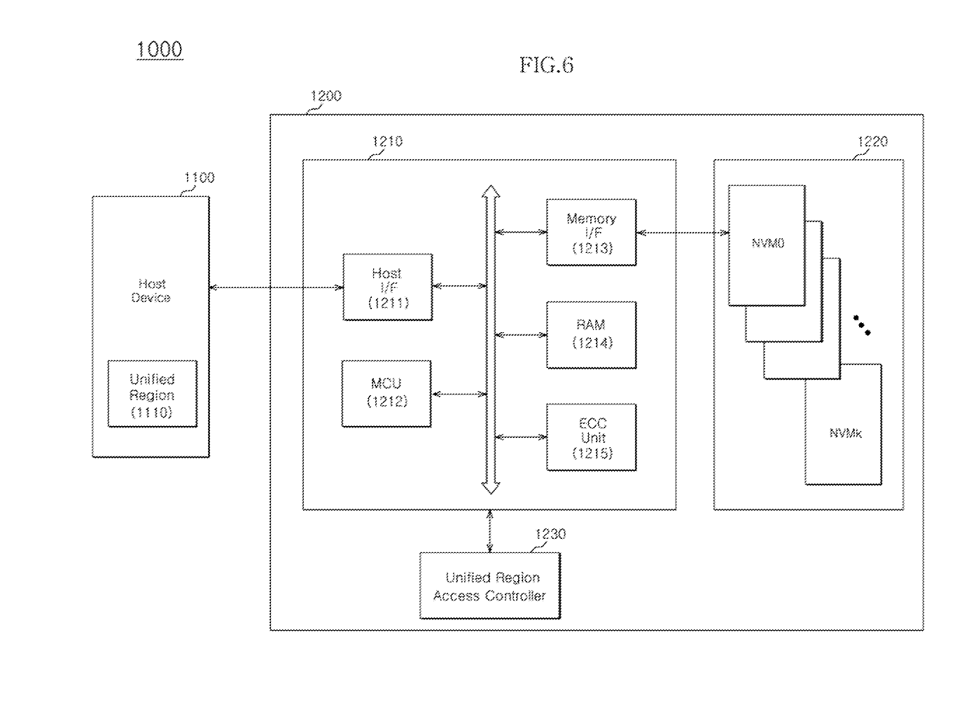

FIG. 5 is a flow chart for explaining a method of using the unified region 121B of the data processing system 100 shown in FIG. 1.

Referring to FIG. 5, a procedure in the case where the host device 110 requests data writing to the data storage device 130 is exemplarily shown. For storing data in the data storage device 130, the host device 110 may transmit write data through the data storage device interface DSD I/F (see FIG. 1). Otherwise, the host device 110 may transmit write data by using the unified region 121B.

In step S210, the host device 110 may provide a write request for storing data to the data storage device 130.

In step S220, the data storage device 130 may select a method for transmitting write data in response to the write request from the host device 110, and may inform a selected transmission method to the host device 110. For instance, the data storage device 130 may make a selection such that write data is transmitted through the data storage device interface DSD I/F, and may request the host device 110 that write data be transmitted through the data storage device interface DSD I/F. For another instance, the data storage device 130 may make a selection so that write data is transmitted using the unified region 121B, and may request the host device 110 that write data be stored in the unified region 121B.

The data transmission procedure in the host device 110 may be changed according to the write data transmission method selected by the data storage device 130. For instance, when the data storage device 130 makes a selection so that write data is transmitted through the data storage device interface DSD I/F, write data may be transmitted as in step S240. For another instance, when the data storage device 130 makes a selection so that write data is transmitted using the unified region 121B, write data may be transmitted as in step S260.

First, the case where the data storage device 130 makes a selection such that write data is transmitted through the data storage device interface DSD I/F will be described below.

In step S241 the host device 110 may transmit write data according to a transfer protocol of the data storage device interface DSD I/F. In step S243, the data storage device 130 may store transmitted write data in the nonvolatile memory device 150. While not shown, before transmitted write data is stored in the nonvolatile memory device 150, the transmitted write data may be temporarily stored, for example, buffered or cached, in the working memory 141.

Second, the case where the data storage device 130 makes a selection so that write data is transmitted using the unified region 121B will be described below.

In step S261, the host device 110 may store write data in the unified region 121B.

In step S263, the host device 110 may inform the data storage device 130 that the storage of write data is completed. In this case, the host device 110 may provide the position information, for example, the address, of the unified region 121B where write data is stored.

In step S265, the data storage device 130 may access the unified region 121B in response to the informing of write data storage completion from the host device 110. The data storage device 130 may perform an access to the unified region 121B through the unified region access controller 160.

In step S267, the data storage device 130 may store the data stored in the unified region 121B in the nonvolatile memory device 150.

As in the steps S261 to S267, the host device 110 and the data storage device 130 may perform data transmission using a shared memory region, that is, the unified region 121B.

While the host device 110 stores write data in the unified region 121B, the data storage device 130 may not access the unified region 121B. For instance, as in steps S268 and S269, if the data storage device 130 accesses the unified region 121B while the host device 110 stores write data in the unified region 121B, the host device 110 may inform that the access of the data storage device 130 is denied. In this case, the data storage device 130 may defer an access until it becomes possible to access the unified region 121B according to the order of priority to access the unified region 121B.

FIG. 6 is a block diagram illustrating a data processing system in accordance with an embodiment of the present invention.

Referring to FIG. 6, a data processing system 1000 may include a host device 1100 and a data storage device 1200.

The host device 1100 may include a unified region 1110 which is included in a working memory (not shown). The unified region 1110 may be a shareable r memory region which may be accessed or used by the host device 1100 and the data storage device 1200. That is, the unified region 1110 may be a region for which an occupation authority (or an access authority) is granted to both the host device 1100 and the data storage device 1200. As the occupation authority is shared, the unified region 1110 may be recognized and allocated as the extended region of a working memory 1214 of the data storage device 1200.

The data storage device 1200 may be used by being electrically coupled to the host device 1100 such as a desktop computer, a notebook computer, a digital camera, a mobile phone, an MP3 player, a game player, and so forth. The data storage device 1200 is also referred to as a memory system. The data storage device 1200 may include a controller 1210, a nonvolatile memory device 1220, and a unified region access controller 1230.

The controller 1210 may access the nonvolatile memory device 1220 in response to a request from the host device 1100. For example, the controller 1210 may control the read, program or erase operation of the nonvolatile memory device 1220. The controller 1210 may drive a firmware for controlling the nonvolatile memory device 1220.

The controller 1210 may include component elements which are well known in the art, such as a host interface (I/F) 1211, a micro control unit (MCU) 1212, a memory interface (I/F) 1213, a RAM 1214, and an error correction code (ECC) unit 1215.

The micro control unit 1212 may control the general operations of the controller 1210 in response to a request from the host device 1100. The RAM 1214 may be used as the working memory of the micro control unit 1212. The RAM 1214 may temporarily store the data read from the nonvolatile memory device 1220 or the data provided from the host 1100.

The host interface 1211 may interface the host device 1100 and the controller 1210. For example, the host interface 1211 may communicate with the host device 1100 through one of various interface protocols such as a universal serial bus (USB) protocol, a universal flash storage (UFS) protocol, an multimedia card (MMC) protocol, a peripheral component interconnection (PCI) protocol, a PCI-express (PCI-E) protocol, a parallel advanced technology attachment (PATH) protocol, a serial advanced technology attachment (SATA) protocol, a small computer system interface (SCSI) protocol, a serial attached SCSI (SAS) protocol, and an integrated drive electronics (IDE) protocol.

The memory interface 1213 may interface the controller 1210 and the nonvolatile memory device 1220. The memory interface 1213 may provide a command and an address to the nonvolatile memory device 1220. Furthermore, the memory interface 1213 may exchange data with the nonvolatile memory device 1220.

The error correction code unit 1215 may detect an error of the data read from the nonvolatile memory device 1220. Also, the error correction code unit 1215 may correct the detected error when the detected error falls within a correctable range. Meanwhile, the error correction code unit 1215 may be provided inside or outside the controller 1210 according to the memory system 1000.

The unified region access controller 1230 may directly perform an access to the unified region 1110, in place of the controller 1210. The unified region access controller 1230 may access the unified region 1110 in response to the address and the request provided from the controller 1210. The unified region access controller 1230 may perform an access to the unified region 1110 through an interface between the host 1100 and the data storage device 1200.

The controller 1210, the nonvolatile memory device 1220 and the unified region access controller 1230 may be integrated into one semiconductor apparatus and may be manufactured as any one of various kinds of storage devices. For example, the controller 1210 and the data storage media 1220 may be integrated into one semiconductor apparatus and may be manufactured as any one of various kinds of storage devices such as a multimedia card in the form, of an MMC, an eMMC, an RS-MMC and a micro-MMC, a secure digital card in the form of an SD, a mini-SD and an micro-SD, a universal serial bus (USB) storage device, a universal flash storage (UFS) device, a personal computer memory card international association (PCMICIA) card, a compact flash (CF) card, a smart media card, a memory stick, and so forth.

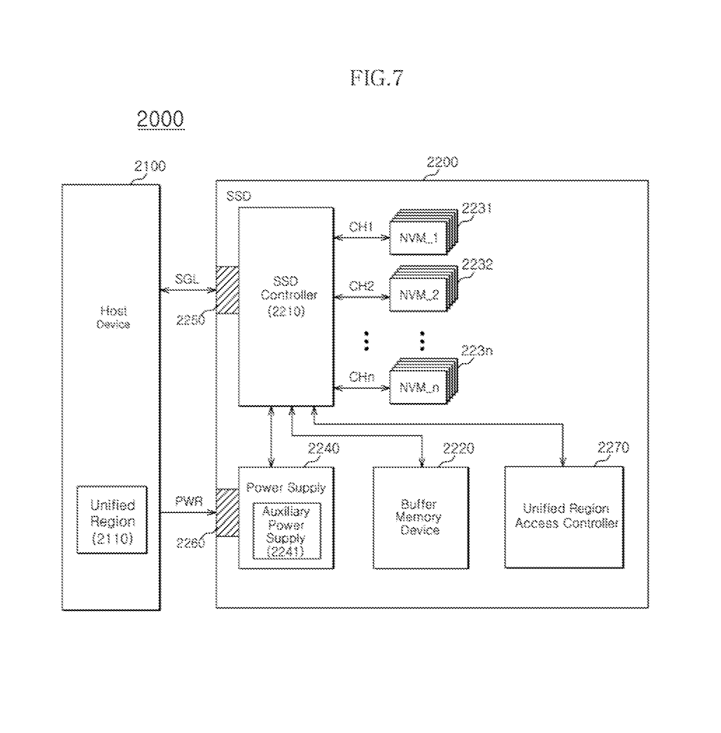

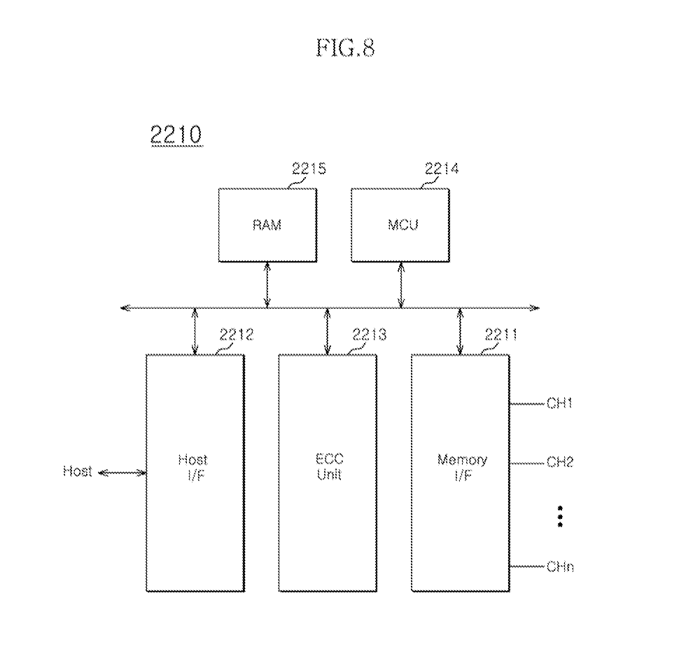

FIG. 7 is a block diagram illustrating a data processing system 2000 with a solid-state drive (SSD) in accordance with an embodiment of the present invention.

Referring to FIG. 7, the data processing system 2000 may include a host device 2100 and an SSD 2200.

The host device 2100 may include a unified region 2110, which is included in a working memory (not shown). The unified region 2110 may be a shareable memory region, which may be accessed or used by both the host device 2100 and the SSD 2200. That is, the unified region 2110 may be a region for which an occupation authority (or an access authority) is granted to both the host device 2100 and the SSD 2200. As the occupation authority is shared, the unified region 2110 may be recognized and allocated as the extended region of a working memory (see the reference numeral 2215 of FIG. 8) or a buffer memory device 2220 of the SSD 2200.

The SSD 2200 may include an SSD controller 2210, the buffer memory device 2220, nonvolatile memory devices 2231 to 223n, a power supply 2240, a signal connector 2250, a power connector 2260, and a unified region access controller 2270.

The SSD 2200 may operate in response to a request from the host device 2100. That is, the SSD controller 2210 may access the nonvolatile memory devices 2231 to 223n in response to a request from the host device 2100. For example, the SSD controller 2210 may control the read, program and erase operations of the nonvolatile memory devices 2231 to 223n. Also, the SSD controller 2210 may perform a dynamic address mapping table backup operation in accordance with the embodiment of the present invention. Accordingly, the operation speed of the SSD 2200 may be increased.

The buffer memory device 2220 may temporarily store data to be stored in the nonvolatile memory devices 2231 to 223n. Further, the buffer memory device 2220 may temporarily store data read from the nonvolatile memory devices 2231 to 223n. The data temporarily stored in the buffer memory device 2220 may be transmitted to the host device 2100 or the nonvolatile memory devices 2231 to 223n under the control of the SSD controller 2210.

The nonvolatile memory devices 2231 to 223n may be used as storage media of the SSD 2200. The nonvolatile memory devices 2231 to 223n may be electrically coupled to the SSD controller 2210 through a plurality of channels CH1 to CHn, respectively. One or more nonvolatile memory devices may be electrically coupled to one channel. The nonvolatile memory devices electrically coupled to one channel may be electrically coupled to the same signal bus and data bus.

The power supply 2240 may provide power PWR inputted through the power connector 2260 to the SSD 2200. The power supply 2240 may include an auxiliary power supply 2241. The auxiliary power supply 2241 may supply power so as to allow the SSD 2200 to be normally terminated when a sudden power-off occurs. The auxiliary power supply 2241 may include super capacitors capable of being charged with power PWR.

The SSD controller 2210 may exchange a signal SGL with the host device 2100 through the signal connector 2250. The signal SGL may include a command, an address, data, and so forth. The signal connector 2250 may include a connector such as a parallel advanced technology attachment (DATA), a serial advanced technology attachment (SATA), a small computer system interface (SCSI) and a serial attached SCSI (SAS) protocols, depending on an interface scheme between the host device 2100 and the SSD 2200.

The unified region access controller 2270, in place of the SSD controller 2210, may directly access the unified region 2110. The unified region access controller 2270 may access the unified region 2110 in response to the address and the request provided from the SSD controller 2210. The unified region access controller 2270 may perform an access to the unified region 2110 through an interface between the host device 2100 and the SSD 2200.

FIG. 8 is a detailed diagram of the SSD controller 2210 shown in FIG. 7.

Referring to FIG. 8, the SSD controller 2210 may include a memory interface (I/F) 2211, a host interface (I/F) 2212, an error correction code (ECC) unit 2213, a micro control unit (MCU) 2214, and a RAM 2215.

The memory interface 2211 may provide a command and an address to the nonvolatile memory devices 2231 to 223n. Moreover, the memory interface 2211 may exchange data with the nonvolatile memory devices 2231 to 223n, The memory interface 2211 may scatter the data transmitted from the buffer memory device 2220 to the respective channels CH1 to CHn, under the control of the micro control unit 2214. Furthermore, the memory interface 2211 may transfer the data read from the nonvolatile memory devices 2231 to 223n to the buffer memory device 2220, under the control of the micro control unit 2214.

The host interface 2212 may interface with the SSD 2200 in correspondence to the protocol of the host device 2100. For example, the host interface 2212 may communicate with the host device 2100 through one of a parallel advanced technology attachment (PATA), serial advanced technology attachment (SATA), a small computer system interface (SCSI) and a serial attached SCSI (SAS) protocols. In addition, the host interface 2212 may perform a disk emulating function of supporting the host device 2100 to recognize the SSD 2200 as a hard disk drive (HDD).

The ECC unit 2213 may generate parity bits based on the data transmitted to the nonvolatile memory devices 2231 to 223n. The generated parity bits may be stored in spare areas of the nonvolatile memory devices 2231 to 223n. The ECC unit 2213 may detect an error of the data read from the nonvolatile memory devices 2231 to 223n. When the detected error falls within a correctable range, the ECC unit 2213 may correct the detected error.

The micro control unit 2214 may analyze and process a signal SGL inputted from the host device 2100. The micro control unit 2214 may control the general operations of the SSD controller 2210 in response to a request from the host device 2100. The micro control unit 2214 may control the operations of the buffer memory device 2220 and the nonvolatile memory devices 2231 to 223n according to a firmware for driving the SSD 2200. The RAM 2215 may be used as a working memory for driving the firmware.

While certain embodiments have been described above, it will be understood to those skilled in the art that the embodiments described are by way of example only. Accordingly, the data processing system described herein should not be limited based on the described embodiments. Rather, the data processing system to described herein should only be limited in light of the claims that follow.

What is claimed is:

1. A data processing system comprising:
a host device including a first working memory; and
a data storage device suitable for responding to an access request from the host device,
wherein the data storage device comprises:
a controller suitable for controlling an operation of the data storage device;
a second working memory suitable for storing data used for driving of the controller; and
an access controller suitable for accessing a shared memory region of the first working memory under the control of the controller.

2. The data processing system according to claim 1, wherein the controller provides an address and an access request for accessing the first working memory to the access controller.

3. The data processing system according to claim 2, wherein the access controller accesses the shared memory region of the first working memory through an interface between the host device and the data storage device, in response to the address and the access request for accessing the first working memory.

4. The data processing system according to claim 1, wherein the controller allocates remote addresses for accessing the shared memory region of the first working memory and local addresses for accessing a memory region of the second working memory.

5. The data processing system according to claim 4, wherein the controller sequentially allocates the remote addresses and the local addresses.

6. The data processing system according to claim 1, wherein the controller uses the shared memory region of the first working memory in substantially the same manner as the second working memory.

7. The data processing system according to claim 6, wherein the controller stores a firmware or a software to be driven by the controller in the shared memory region of the first working memory and the memory region of the second working memory.

8. The data processing system according to claim 6, wherein the controller stores data provided from the host device in the shared memory region of the first working memory and the memory region of the second working memory, or store data to be provided to the host device in the shared memory region of the first working memory and the memory region of the second working memory.

9. The data processing system according to claim 1, wherein the data storage device further comprises:
a data storage medium suitable for storing data provided from the host device.

10. The data processing system according to claim 9, wherein the data storage medium comprises one or more nonvolatile memory devices.

11. The data processing system according to claim 9, wherein the data storage medium comprises a flash memory device and a nonvolatile random access memory device,

12. A data processing system comprising:
a host device; and
a data storage device suitable for communicating with the host device through an interface, and storing data to be accessed by the host device,
wherein the host device provides a write request for write data to the data storage device,
wherein the data storage device selects a transmission method for the write data in response to the write request, and informs the selected transmission method to the host device, and
wherein the host device transmits the write data based on the selected transmission method.

13. The data processing system according to claim 12,
wherein the host device comprises a first working memory, which is shared by the data storage device, and
wherein the data storage device selects any one of a first transmission method in which the write data is transmitted according to a transfer protocol of the interface and a second transmission method in which the write data is transmitted via a shared region of the first working memory.

14. The data processing system according to clam 13, wherein, when the write data is transmitted based on the second transmission method, the host device stores the write data in a partial memory region of the first working memory and inform the data storage device that storage of the write data is completed.

15. The data processing system according to claim 14, wherein the data storage device accesses the partial memory region of the first working memory where the write data is stored, and stores the write data in a nonvolatile memory device.

16. The data processing system according to claim 15, wherein the data storage device comprises:
a second working memory;
a controller suitable for controlling an operation of the data storage device through driving of a firmware loaded on the second working memory; and
an access controller suitable for accessing a memory region of the first working memory where the write data is stored, under the control of the controller.

17. The data processing system according to claim 16, wherein the controller allocates remote addresses for accessing the partial memory region of the first working memory and local addresses for accessing a memory region of the second working memory.

18. The data processing system according to claim 17, wherein the controller sequentially allocates the remote addresses and the local addresses.

19. The data processing system according to claim 13,
wherein, when the first transmission method is selected, the host device transmits the write data through the interface, and the data storage device stores the transmitted write data in a nonvolatile memory device included in the data storage device.

20. A data processing system comprising:
a host device with a first working memory; and
a data storage device suitable for responding to an access request from the host device,
wherein the data storage device comprises:
a controller with a second working memory and suitable for controlling an operation of the data storage device;
an access controller suitable for accessing a shared memory region included the first working memory under the control of the controller; and
a data storage medium suitable for storing data provided from the host device.
